(19) United States
(12) Patent Application Publication
(10) Pub. No.: US 2013/0329756 A1
(43) Pub. Date: Dec. 12, 2013

(54) LASER APPARATUS

(71) Applicant: INDUSTRIAL TECHNOLOGY RESEARCH INSTITUTE, HSINCHU (TW)

(72) Inventors: SHIH TING LIN, TAINAN CITY (TW); YAO WUN JHANG, CHIAYI CITY (TW); CHIEN MING HUANG, CHIAYI CITY (TW); HSIN CHIA SU, YUNLIN COUNTY (TW); CHIH LIN WANG, TAINAN CITY (TW); HONG XI TSAU, KAOHSIUNG COUNTY (TW)

(73) Assignee: INDUSTRIAL TECHNOLOGY RESEARCH INSTITUTE, HSINCHU (TW)

(21) Appl. No.: 13/963,873

(22) Filed: Aug. 9, 2013

Related U.S. Application Data
(63) Continuation of application No. 13/339,122, filed on Dec. 28, 2011.

(30) Foreign Application Priority Data
Oct. 31, 2011 (TW) 100139524

(51) Int. Cl. H01S 3/067

(52) U.S. Cl. CPC H01S 3/067
USPC 372/6

(57) ABSTRACT

A laser apparatus includes an optical fiber component and a pump light source coupled to the optical fiber component. The optical fiber component includes a first fiber segment, a second fiber segment and a connecting segment that connects the first and second fiber segments. The first fiber segment includes a fiber core having a first diameter, and the second fiber segment includes a fiber core having a second diameter. The first diameter may be greater than the second diameter, and the connecting segment may have a periodically varying refractive index.

### CROSS REFERENCE TO RELATED APPLICATION

This application is a continuation of prior application Ser. No. 13/339,122, filed on 28 Dec. 2011 by the present inventor, entitled “LASER APPARATUS”, which is hereby incorporated by reference.

### TECHNICAL FIELD

The present invention relates to a laser apparatus, and relates more particularly to a fiber laser apparatus.

### BACKGROUND

In a fiber laser, a laser-active medium is incorporated in a light waveguide. Laser activity of a fiber can be attained by doping its fiber core with ions of rare earth minerals. Pump light from a pump light source coupled to the fiber can effect excitation of the ions. The pump light can be longitudinally irradiated into the fiber and absorbed by the ions. The pump light can be focused, with the aid of a lens, to the front end of the fiber and coupled into the fiber core.

In recent years, short optical pulse generation has been increasingly used in many applications including laser-based micromachining, thin-film formation, laser cleaning, medicine and biology. Advantages are achieved when short pulses are employed. For example, using short pulses in ablation of various materials may minimize the thermal or shock damage to the surrounding material. Moreover, short pulses may reduce heat-affected zones and shock affected zones, allowing micro-fabrication to achieve higher spatial resolution.

An amplifier can be used in a conventional optical fiber laser to amplify laser signals. FIG. 1 illustrates a conventional optical fiber laser system 1 having two stages of amplifiers 12 and 13. As shown in FIG. 1, the conventional optical fiber laser system 1 comprises a laser seed source 11 and two amplifiers 12 and 13, which are serially connected. The two amplifiers 12 and 13 may be similar. Each amplifier 12 or 13 may comprise a pump light source 122 or 132, a combiner 123 or 133, and an optical fiber 124 or 134. The optical fiber laser system 1 may further comprise an isolator 14 disposed between the laser seed source 11 and the amplifier 12 and another isolator 15 disposed between the amplifiers 12 and 13. The isolators 14 and 15 can ensure correct direction of light transmission and prevent any noise in the optical fiber 124 or 134 from transmitting back to the laser seed source 11 or a pre-stage amplifier. The combiner 123 or 133 combines the laser beam from the isolator 14 or 15 and the laser beam from the corresponding pump light source 122 or 132, and outputs a combined laser beam into the corresponding optical fiber 124 or 134. The pump light source 122 or 132 is used to provide energy for increasing power. The pump light sources 122 and 132 can be different, thereby providing different amplifying energy levels to meet the different requirements of the two stages of amplifiers 12 and 13. The cores of the optical fibers 124 and 134 can be different. Normally, the core of the optical fiber 124 can be smaller than that of the optical fiber 134.

Traditionally, to produce higher power lasers, many more similar amplifiers are needed in the conventional optical fiber laser, and more corresponding isolators are required to be disposed between the laser seed source and an amplifier and between the amplifiers.

### SUMMARY

One embodiment of the disclosure discloses a laser apparatus, which comprises an optical fiber component and a pump light source coupling to the optical fiber component. The optical fiber component may comprise a first fiber segment, a second fiber segment, and a connecting segment. The first fiber segment may comprise a fiber core that may comprise a first diameter. The second fiber segment may comprise a fiber core that may comprise a second diameter. The second diameter may be greater than the first diameter. The connecting segment may connect the first and second fiber segments and comprise a periodically varying index of refraction. The pump light source may be coupled to the optical fiber component and generate a pump light with a wavelength.

One embodiment of the disclosure discloses another laser apparatus, which comprises an optical fiber component and a pump light source coupling to the optical fiber component. The optical fiber component may comprise a first fiber segment, a second fiber segment, and a connecting segment. The first fiber segment may comprise a fiber core that may comprise a first diameter that may be configured to be in a range of from 3.5 micrometers to 26 micrometers. The second fiber segment may comprise a fiber core that may comprise a second diameter that may be configured to be in a range of from 10 micrometers to 30 micrometers. The connecting segment may connect the first and second fiber segments and comprise a periodically varying index of refraction. The pump light source may be coupled to the optical fiber component and generate a pump light with a wavelength that is configured to be in a range of from 900 nanometers to 930 nanometers or in a range of from 960 nanometers to 990 nanometers.

One embodiment of the disclosure discloses another laser apparatus, which may comprise an optical fiber component and a pump light source coupled to the optical fiber component. The optical fiber component may be configured to output a laser beam, which may comprise a first wavelength. The first fiber segment may comprise a fiber core that may comprise a first diameter. The second fiber segment may comprise a fiber core that may comprise a second diameter that may be greater than the first diameter. The connecting segment may connect the first and second fiber segments and comprise a periodically varying index of refraction. The pump light source may be coupled to the optical fiber component and generate a pump light. The connecting segment is configured to be able to allow a portion of the pump light to transmit and redirect light with the first wavelength propagating from the fiber core of the second fiber segment toward the first fiber segment.

### BRIEF DESCRIPTION OF THE DRAWINGS

The invention will be described according to the appended drawings in which:

FIG. 1 illustrates a conventional optical fiber laser system having two stages of amplifiers;

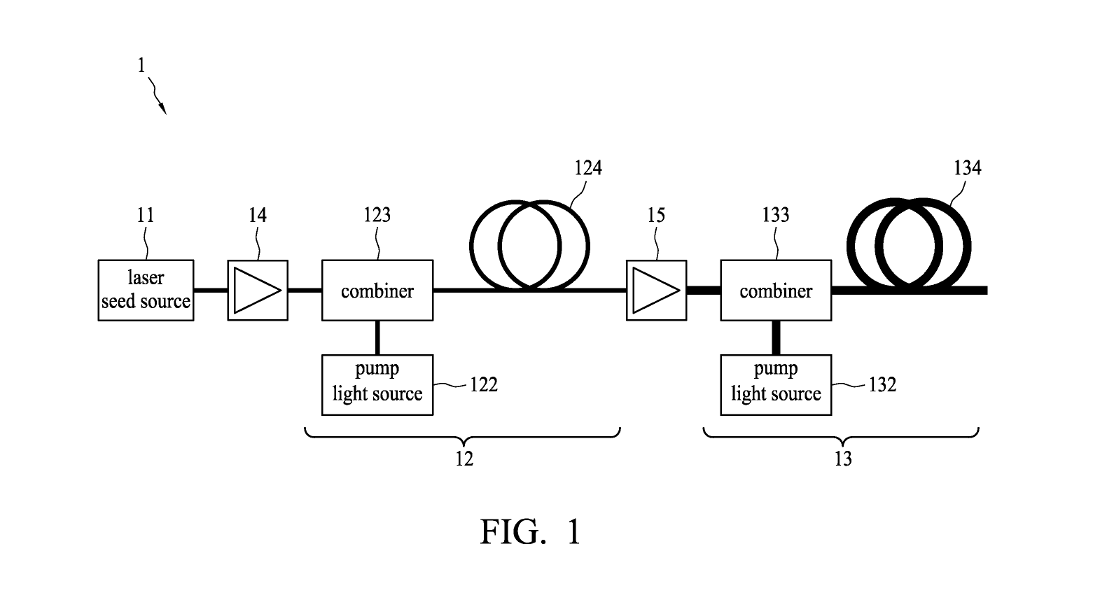

FIG. 2 schematically illustrates a laser apparatus according to one embodiment;

FIG. 3 schematically illustrates an optical fiber component according to one embodiment;

FIG. 4 schematically illustrates that a connecting segment redirects a light transmitting from a second fiber segment toward a first fiber segment according to one embodiment;

FIG. 5 schematically illustrates a laser apparatus according to another embodiment; and

FIG. 6 schematically illustrates a laser apparatus according to another embodiment.

### DETAILED DESCRIPTION OF DISCLOSED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

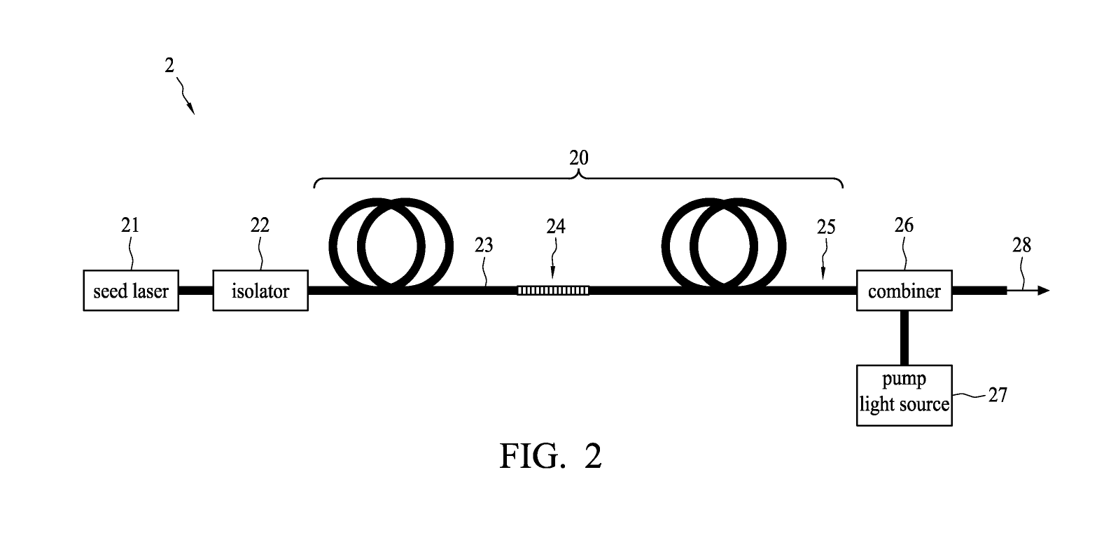

FIG. 2 schematically illustrates a laser apparatus 2 according to one embodiment. Referring to FIG. 2, the laser apparatus 2 may comprise a seed laser 21, an optical fiber component 20, and a pump light source 27. The seed laser 21 can provide high quality, low power laser signals, which are introduced into the fiber core of a connected optical fiber. In some embodiments, the seed laser 21 may be an ultrafast laser system that can emit a laser beam comprising a pulse width less than one nanosecond (pulse width ≦10⁻⁹ s). The optical fiber component 20 may comprise a first fiber segment 23, a connecting segment 24, and a second fiber segment 25, in which the connecting segment 24 connects the first fiber segment 23 and the second fiber segment 25. The pump light source 27 can be coupled to the optical fiber component 20, providing amplifying energy.

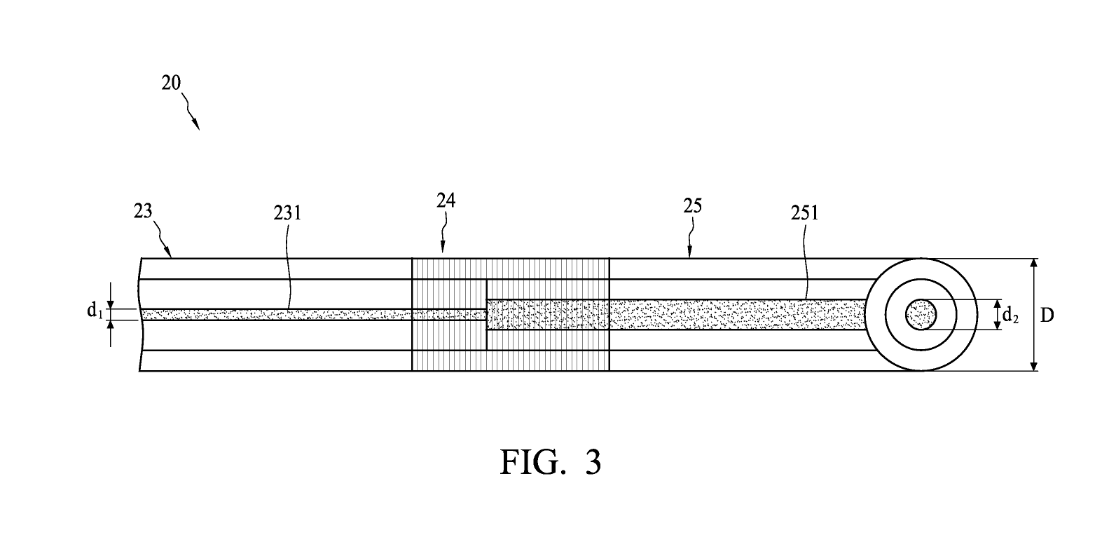

FIG. 3 schematically illustrates the first fiber segment 23, the connecting segment 24, and the second fiber segment 25 according to one embodiment. Referring to FIGS. 2 and 3, the first fiber segment 23 may comprise a fiber core 231, which may comprise a diameter d₁. The second fiber segment 25 may comprise a fiber core 251, which can comprise a diameter d₂. The diameter d₂ of the fiber core 251 may be greater than the diameter d₁ of the fiber core 231. The connecting segment 24 connects the first fiber segment 23 and the second fiber segment 25 and may comprise a periodically varying index of refraction. The pump light source 27 provides a pump light, which may have a wavelength. The connecting segment 24 may be configured to reflect a portion of the pump light back to the second fiber segment 25 and to allow a portion of the pump light to enter the first fiber segment 23. In some embodiments, the connecting segment 24 can be configured to have reflectivity, at the wavelength of the pump light, in the range of from 10% to 80%. In some embodiments, the connecting segment 24 can be configured to have reflectivity, at the wavelength of the pump light, in the range of from 60% to 70%.

In some embodiments, the diameter d₁ of the fiber core 231 of the first fiber segment 23 may be in the range of from 3.5 micrometers to 26 micrometers.

In some embodiments, the diameter d₂ of the fiber core 251 may be in the range of from 10 micrometers to 30 micrometers.

Referring to FIG. 2, because the connecting segment 24 has reflectivity in the range of from 10% to 80%, the pump light from the pump light source 27 can be used to amplify the laser signals propagating in the fiber core 251 of the second fiber segment 25, and can even partially transmit through the connecting segment 24, entering into the first fiber segment 23, amplifying the laser signals propagating in the fiber core 231 of the first fiber segment 23. Consequently, the laser signals propagating in the first fiber segment 23 can also be amplified without needing an additional pump light source.

In some embodiments, the connecting segment 24 may comprise a fiber Bragg grating. In some embodiments, the fiber Bragg grating can be formed by an ultraviolet interference method. The index of refraction of an exposed fiber may change according to the interfered light intensity distribution. In some embodiments, the fiber Bragg grating is formed on the first fiber segment 23 such that the connecting segment 24 may have a diameter similar to the diameter d₁. In some embodiments, the fiber Bragg grating is formed on the second fiber segment 25 such that the connecting segment 24 may have a diameter similar to the diameter d₂. In some embodiments, the fiber Bragg grating is formed on the junction of the first fiber segment 23 and the second fiber segment 25 such that a portion of the fiber core of the connecting segment 24 has a diameter similar to the diameter d₁ while a portion of the fiber core of the connecting segment 24 has a diameter similar to the diameter d₂.

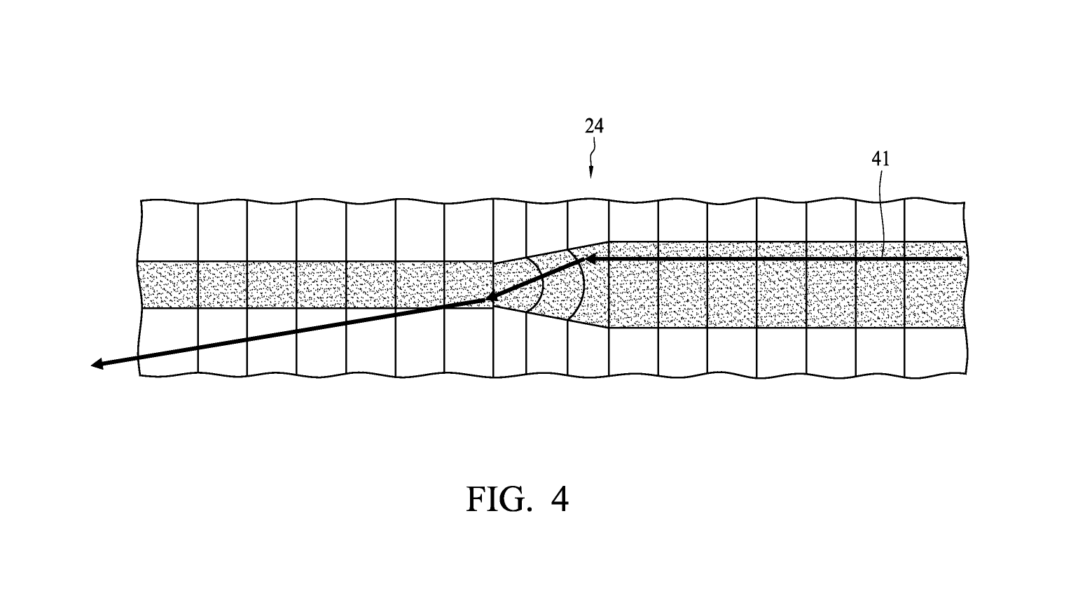

Referring to FIGS. 2 to 4, in some embodiments, the laser apparatus 2 may output a laser beam 28. The pump light source 27 can generate a pump light introduced into the second fiber segment 25. The connecting segment 24 connects the first fiber segment 23 and the second fiber segment 25, wherein the fiber core 231 of the first fiber segment 23 is smaller than the fiber core 251 of the second fiber segment 25. The connecting segment 24 is configured to have a periodically varying index of refraction so as to allow a portion of the pump light to enter into the first fiber segment 23 from the second fiber segment 25. The connecting segment 24 may be further configured to redirect or change the direction of light 41, including radiation of spontaneous emission, propagating from the fiber core 251 of the second fiber segment 25 toward the first fiber segment 23, and having a wavelength similar to that of the laser beam 28, as shown in FIG. 4. As such, the connecting segment 24 can function as an isolator. In some embodiments, the laser beam 28 may have a wavelength in the range of from 1010 nanometers to 1080 nanometers. In some embodiments, the pump light may have a wavelength in a range of from 900 nanometers to 930 nanometers. In some embodiments, the pump light may have a wavelength in a range of from 960 nanometers to 990 nanometers.

Referring to FIG. 3, in some embodiments, the fiber core 231 of the first fiber segment 23 may have an area of A₁, the fiber core 251 of the second fiber segment 25 may have an area of A₂, and the connecting segment 24 may have a transmittance of X. A preferred result can be obtained when the following condition is satisfied:

$$\frac{{A}_{1}}{X} = \frac{{A}_{2}}{1 - X}$$

In some embodiments, the isolation of the connecting segment 24 may be 25 dB. Namely, the ratio of the intensity of the light transmitting from the fiber core 231 of the first fiber segment 23 to the fiber core 251 of the second fiber segment 25 to the intensity of the light transmitting from the fiber core 251 of the second fiber segment 25 to the fiber core 231 of the first fiber segment 23 may be 25 dB. Therefore, the connecting segment 24 can provide a function of isolating light.

Referring to FIG. 2 again, in some embodiments, the laser apparatus 2 may further comprise a combiner 26 connecting the second fiber segment 25 and the pump light source 27. In some embodiments, the combiner 26 can be disposed adjacent to the output end of the second fiber segment 25 for outputting the laser beam 28. In addition, in some embodiments, the laser apparatus 2 may further comprise an isolator 22 connecting the seed laser 21 and the optical fiber component 20. The isolator 22 can ensure that the laser beam from the seed laser 21 is introduced into the optical fiber component 20 in a unidirectional manner.

Referring to FIG. 3, in some embodiments, the first fiber segment 23 may be a double cladding fiber. The diameter D of the outer cladding of the first fiber segment 23 may be in a range of from 100 micrometers to 300 micrometers. In some embodiments, the second fiber segment 25 may be a double cladding fiber. The diameter D of the outer cladding of the second fiber segment 25 may be in a range of from 100 micrometers to 300 micrometers. In some embodiments, the diameter of the outer cladding of the first fiber segment 23 can be similar to that of the outer cladding of the second fiber segment 25.

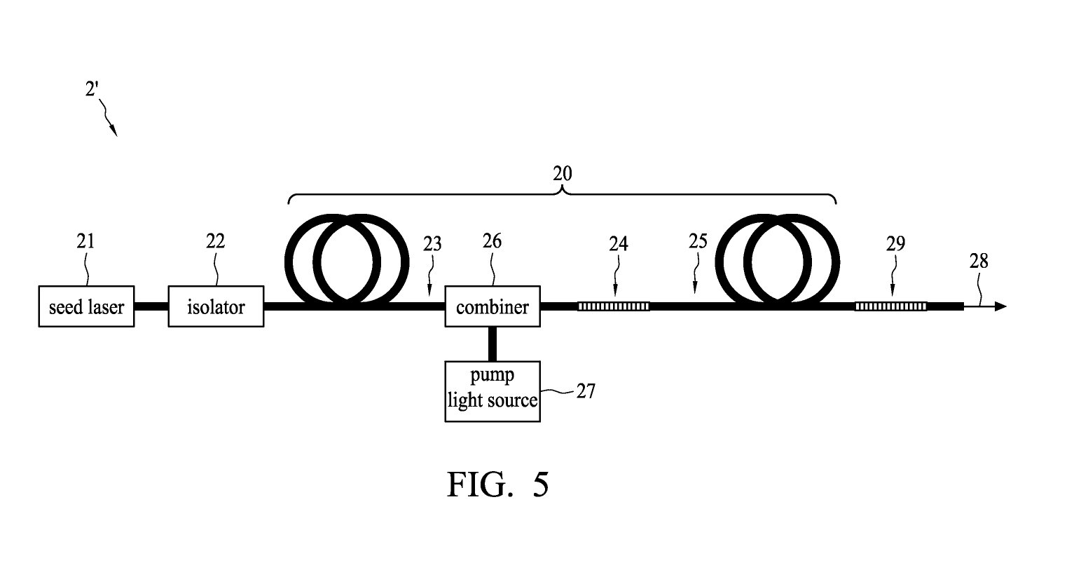

FIG. 5 schematically illustrates a laser apparatus 2′ according to another embodiment. As shown in FIG. 5, the laser apparatus 2′ may generate a laser beam 28, and comprise a seed laser 21, an optical fiber component 20, a combiner 26, and a pump light source 27. The optical fiber component 20 may comprise a first fiber segment 23, a connecting segment 24, and a second fiber segment 25, wherein the second fiber segment 25 may have a larger fiber core in comparison with the first fiber segment 23. The seed laser 21 can be coupled to the first fiber segment 23, and an isolator 22 can be disposed between the seed laser 21 and the first fiber segment 23. The pump light source 27 may be coupled to the first fiber segment 23 via the combiner 26. The connecting segment 24 connects the first fiber segment 23 and the second fiber segment 25. The connecting segment 24 may comprise a periodically varying index of refraction so as to reflect the pump light from the pump light source 27 and allow a portion of the pump light to transmit therethrough to provide amplifying energy to the second fiber segment 25.

The laser apparatus 2′ may further comprise a reflecting segment 29 disposed on the second fiber segment 25, adjacent to the output end outputting the laser beam 28. The reflecting segment 29 may comprise a periodically varying index of refraction. The reflecting segment 29 may comprise a fiber Bragg grating. The reflecting segment 29 may have high reflectivity. In some embodiments, the reflecting segment 29 may have high reflectivity or reflectivity of, for example, greater than 80% to the pump light from the pump light source 27.

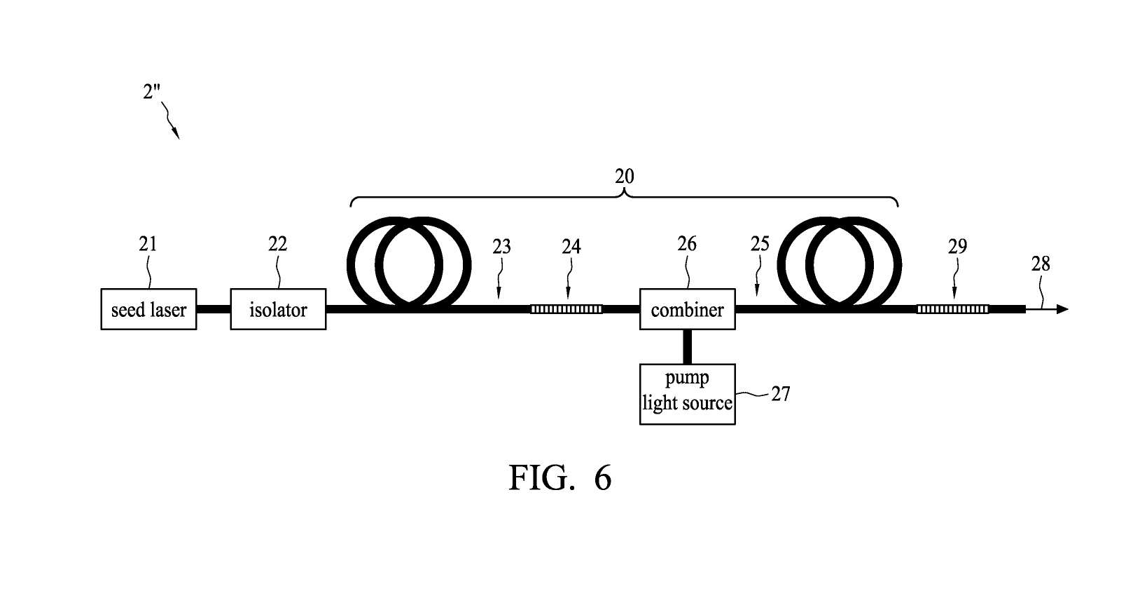

FIG. 6 schematically illustrates a laser apparatus 2″ according to another embodiment. As shown in FIG. 6, the laser apparatus 2″ can generate a laser beam 28, and may comprise a seed laser 21, an optical fiber component 20, a combiner 26, and a pump light source 27. The optical fiber component 20 may comprise a first fiber segment 23, a connecting segment 24, and a second fiber segment 25, wherein the second fiber segment 25 may have a larger fiber core in comparison with the first fiber segment 23. The seed laser 21 may couple to the first fiber segment 23, and an isolator 22 may be disposed between the seed laser 21 and the first fiber segment 23. The connecting segment 24 connects the first fiber segment 23 and the second fiber segment 25. The pump light source 27 may couple to the second fiber segment 25 via the combiner 26, wherein the combiner 26 may be located adjacent to the connecting segment 24. The connecting segment 24 may have a periodically varying index of refraction, can reflect the pump light from the pump light source 27 back to the second fiber segment 25, and can allow a portion of the pump light transmit therethrough to provide amplifying energy to the first fiber segment 23.

The laser apparatus 2″ may further comprise a reflecting segment 29, which may be disposed on the second fiber segment 25, adjacent to the output end outputting the laser beam 28. The reflecting segment 29 may have periodically varying index of refraction. The reflecting segment 29 may comprise a fiber Bragg grating. The reflecting segment 29 may have high reflectivity. In some embodiments, the reflecting segment 29 may have high reflectivity or reflectivity of, for example, greater than 80% to the pump light from the pump light source 27.

It will be apparent to those skilled in the art that various modifications and variations can be made to the disclosed embodiments. It is intended that the specification and examples be considered as exemplary only, with a true scope of the disclosure being indicated by the following claims and their equivalent.

What is claimed is:

1. An optical fiber structure comprising:
a first fiber segment comprising a fiber core having a first diameter, the first fiber segment configured to transmit a first laser beam;
a second fiber segment comprising a fiber core having a second diameter greater than the first diameter, the second fiber segment configured to transmit a second laser beam;
a Bragg grating extending across a junction between the first fiber segment and the second fiber segment; and
a pump light source for transmitting pump light from the second fiber segment to the first fiber segment, wherein a first portion of the pump light penetrates through the Bragg grating to enhance the first laser beam, and a second portion of the pump light is reflected by the Bragg grating to enhance the second laser beam.

2. The optical fiber structure of claim 1, wherein the second fiber segment has an output for outputting a laser beam.

3. The optical fiber structure of claim 2 further comprising a combiner coupled with the pump light source, wherein the combiner is disposed between the output and the second fiber segment.

4. The optical fiber structure of claim 1 further comprising a combiner coupled with the pump light source, wherein the combiner is disposed between the second fiber segment and the junction.

5. The optical fiber structure of claim 1, wherein the first diameter is in a range from 3.5 micrometers to 10 micrometers.

6. The optical fiber structure of claim 1, wherein the second diameter is in a range from 10 micrometers to 30 micrometers.

7. The optical fiber structure of claim 1, wherein each of the first and the second fiber segment comprises a double cladding having a diameter in a range from 100 micrometers to 300 micrometers.

8. The optical fiber structure of claim 1, wherein a reflectivity of the Bragg grating is in a range from 10% to 80%.

9. An optical fiber structure comprising:
a first fiber segment comprising a fiber core having a first diameter, the first fiber segment configured to transmit a first laser beam;
a second fiber segment comprising a fiber core having a second diameter greater than the first diameter, the second fiber segment configured to transmit a second laser beam;
a Bragg grating extending across a junction between the first fiber segment and the second fiber segment; and
a pump light source for transmitting pump light from the first fiber segment to the second fiber segment, wherein a first portion of the pump light is reflected by the Bragg grating to enhance the first laser beam, and a second portion of the pump light penetrates through the Bragg grating to enhance the second laser beam.

10. The optical fiber structure of claim 9, wherein the second fiber segment has an output for outputting a laser beam.

11. The optical fiber structure of claim 9 further comprising a combiner coupled with the pump light source, wherein the combiner is disposed between the first fiber segment and the junction.

12. The optical fiber structure of claim 9, wherein the first diameter is in a range from 3.5 micrometers to 10 micrometers.

13. The optical fiber structure of claim 9, wherein the second diameter is in a range from 10 micrometers to 30 micrometers.

14. The optical fiber structure of claim 9, wherein each of the first and the second fiber segment comprises a double cladding having a diameter in a range from 100 micrometers to 300 micrometers.

15. The optical fiber structure of claim 9, wherein a reflectivity of the Bragg grating is in a range from 10% to 80%.

16. A connecting structure for a first fiber core having a first diameter and a second fiber core having a second diameter, the connecting structure comprising:
a Bragg grating extending across a junction between the first fiber core and the second fiber core; and
a pump light source for transmitting pump light, wherein a first portion of the pump light penetrates through the Bragg grating to enhance a first laser beam inside the first fiber core, and a second portion of the pump light is reflected by the Bragg grating to enhance a second laser beam inside the second fiber core.

17. The connecting structure of claim 16, wherein the second fiber core has an output for outputting a laser beam.

18. The connecting structure of claim 16, wherein the first fiber core is smaller than the second fiber core, the first fiber core is in a range from 3.5 micrometers to 10 micrometers, and the second fiber core is in a range from 10 micrometers to 30 micrometers.

19. The connecting structure of claim 16 further comprising a double cladding having a diameter in a range from 100 micrometers to 300 micrometers.

20. The connecting structure of claim 16, wherein a reflectivity of the Bragg grating is in a range from 10% to 80%.
